(19) United States
(12) Patent Application Publication
(10) Pub. No.: US 2004/0265641 A1
(43) Pub. Date: Dec. 30, 2004

(54) Substrate for magnetic recording medium

(76) Inventors: Masatoshi Ishii, Takefu-shi (JP); Toshihiro Tsumori, Takefu-shi (JP); Yu Hamaguchi, Takefu-shi (JP); Yukimi Jyoko, Sabae-shi (JP)

Correspondence Address: Myers Bigel Sibley & Sajovec, Post Office Box 37428, Raleigh, NC, 27627, US

(21) Appl. No.: 10/879,795

(22) Filed: Jun. 29, 2004

(30) Foreign Application Priority Data
Jul. 10, 2003 (JP) 2003-194784
Jul. 10, 2003 (JP) 2003-194785
Jun. 30, 2003 (JP) 2003-186970

(51) Int. Cl. G11B 5/64; B32B 5/16

(52) U.S. Cl. 428/694 T; 428/143; 428/145; 428/149; 428/336; 428/694 TS; 428/701; 428/900

(57) ABSTRACT

The present invention provides a surface-treated substrate for a magnetic recording medium, and a magnetic recording medium comprising a recording layer, wherein the surface-treated substrate can contain thick film which has adhesion strong enough to withstand leveling process such as polishing in the formation of film on the Si substrate. More specifically, the present invention provides a surface-treated substrate for a magnetic recording medium, comprising a Si substrate and a primer plating layer on the Si substrate, wherein the primer plating layer is film which comprises a metal and a Si oxide. Furthermore, the present invention provides a surface-treated substrate for a magnetic recording medium, comprising a Si substrate and a primer plating layer on the Si substrate, wherein at least 5 and at most 50 protrusions of a height of at least 100 nm per 100 μm² are present on a surface of the primer plating layer. Even further, the present invention provides a surface-treated substrate for a magnetic recording medium, comprising a Si substrate, a primer plating layer on the Si substrate and a soft magnetic layer above the primer plating layer, wherein a non-magnetic middle layer is provided between the primer plating layer and the soft magnetic layer.

### BACKGROUND OF THE INVENTION

1. Field of the Invention

The present invention relates to a magnetic recording medium which comprises a substrate for a magnetic recording medium and a recording layer.

2. Description of the Related Art

In the field of magnetic recording, information recording by hard disk devices is indispensable for primary external recording devices for computers, such as personal computers for example. As the recording densities of hard disk drives increase, the development of perpendicular magnetic recording types in which even higher density recording is possible is advancing, replacing the conventional longitudinal magnetic recording types of hard disk drives.

In perpendicular magnetic recording, the magnetic field from adjacent bits is in the same direction as the magnetizing direction, forming a closed magnetic circuit between adjacent bits, and there is less self-reducing magnetic field (referred to below as a “diamagnetizing field”) caused by self magnetization than in horizontal magnetic recording, stabilizing the magnetizing condition.

In perpendicular magnetic recording there is no particular necessity to make the magnetic film thin with increases in recording density. From these points, the perpendicular magnetic recording can reduce the diamagnetizing field and secure KᵤV values, wherein Kᵤ represents anisotropic energy, in particular the crystalline magnetic anisotropic energy in the case of magnetic recording, and V expresses the volume of a unit recording bit. Accordingly, it has stability against magnetization by thermal fluctuations and is believed to be a recording method that makes it possible to push the recording limit significantly upward. As recording media, perpendicular recording media have a high affinity with horizontal recording media, and it is possible to use basically the same technology as was used conventionally and in both reading and writing of magnetic recording.

Perpendicular magnetic recording media comprise a soft magnetic lining layer (typically of permalloy or the like), a recording film (for which candidate materials are CoCr-based alloy, multi-layer films of alternating laminated layers of PtCo layers and ultra thin films of Pd and Co, and SmCo amorphous film), a protective layer, and a lubricating layer, formed on a substrate. It is necessary that the lining layer of the perpendicular magnetic recording medium is soft magnetic, and has a film thickness of about 100 nm to about 500 nm. As well as being the path for magnetic flux from the recording film above it, the soft magnetic lining layer is also the path for the writing flux from the recording head. Because of this, it play the same role as an iron yoke in the magnetic circuit of a permanent magnet so that it is required to be a thick film.

Compared to formation of non-magnetic Cr-based primer film in a horizontal recording medium, it is not a simple matter to form the soft magnetic lining film of the perpendicular recording medium. Ordinarily, the films constituting a horizontal recording medium are all formed by a dry process (principally by magnetron sputtering) (Japanese Patent Provisional Publication No. 5-143972/1993). Film formation by dry processing has been investigated for perpendicular recording media as well. However, from the aspect of mass-production and productivity, there are large problems with film formation by dry processing because of process stability, the complexity of parameter settings, and more than anything else, process speed. Furthermore, for the purpose of achieving higher densities, it is necessary to make the height at which the head floats above the surface of the magnetic disk (the flying height) as low as possible. Accordingly, in the manufacture of the perpendicular magnetic recording medium, it is necessary to cover the substrate with a metal film of such a thickness that it can be leveled by grinding. However, because the adhesion of thick film obtained by a dry process is low, leveling by grinding is very problematic. Thus, various tests were performed to cover a non-magnetic substrate with a metal film by a plating method, with which a thick film can be formed more easily than by vacuum deposition.

In order to perform plating with favorable adhesion by wet process plating, it is very important that material which can act as a catalyst for reducing metal ions in the plating solution exists in large quantities at junction sites between the plating film and the base material. Furthermore, the adhesive strength between the plating film which is formed and the plated substrate depends on a mechanical anchoring effect due to unevenness of the surface of the plated substrate, or on chemical interactions between the plated substrate and the plating film.

For example, in order to plate the surface of a material which is poor in chemical reactivity, such as plastic, ceramics or glass, a method for securing adhesion based on mechanical anchoring is widely used, wherein colloidal particles are fixed to indented portions of the surface by dipping the substrate into a Pd—Sn colloidal solution after roughening the surface of the substrate by polish or the like, and plating is carried out using these adhered colloids as catalytic starting points.

On the other hand, when plating a surface of metal such as Fe or the like, metallic bonds are formed between the plating film and the plated metal immediately after starting the plating, and it is believed that strong adhesion is ensured by generation of an alloy at the atomic layer level.

On the other hand, the surface of a silicon wafer used as the plating substrate is extremely reactive with oxygen. Thus, in several hours after the production of the silicon wafer, it is deactivated by being covered by a natural oxide film of SiO₂ whose surface is of low chemical activity. For this reason, it is difficult to form chemical bonds with the plating film.

It is widely known that the natural oxide film of the Si surface can be dissolved for removal by soaking in HF or the like. However, the surface of the Si which has had its natural oxide film removed oxidizes very easily, so that before the plating film can be formed, the oxide film is formed again by reaction with OH groups in the solution when it is soaked in the plating solution. Consequently, a favorable plating film cannot be obtained.

Because of this, when plating a Si substrate, plating is carried out by soaking in a Pd—Sn colloid after roughening the surface of the substrate in a similar manner to that previously described when plating plastic or the like. Alternatively, it can be performed by plating a metal layer formed by vapor phase deposition such as sputtering.

However, in the process of plating after roughening the substrate, if the adhesivity of the plating layer is to be increased, it is necessary to increase the roughness of the surface of the substrate accordingly. Consequently, it is not suitable for plating a semiconductor wafer or the like used in electronic materials or the like. Furthermore, if the substrate surface is roughened by mechanical processing, marks from the process are generated, and depending on the dimensions and shape of the marks, the problem of a considerable loss of substrate strength-occurs.

### SUMMARY OF THE INVENTION

It is an object of the invention to provide a surface-treated substrate for a magnetic recording medium, and a magnetic recording medium comprising a recording layer, wherein the surface-treated substrate can contain thick film which has adhesion strong enough to withstand leveling process such as polishing in the formation of film on the Si substrate.

According to a first aspect of the invention, as a result of repeated keen investigations into a surface-treated substrate for magnetic recording medium, a soft magnetic layer and a magnetic recording medium comprising a recording layer, wherein the surface-treated substrate can contain thick film which has adhesion to a Si substrate, the inventors found that in order to achieve the object described above, it is effective to use a surface-treated substrate for a magnetic recording medium comprising a Si substrate, a primer plating layer on the Si substrate, and preferably a soft magnetic layer on or above the primer plating layer, wherein the primer plating layer is film which comprises a metal and a Si oxide. The inventors have also found that a primer plating layer whose metal content increases with increasing distance from a face of the Si substrate is particularly effective. The inventors further found that it is preferable when the metal of the primer plating layer comprises at least one metal selected from the group consisting of Ag, Co, Cu, Ni, Pd and Pt, or is an alloy which comprises the metal thereof. The inventors have also found that a magnetic recording medium which comprises a surface-treated substrate for a magnetic recording medium comprising a soft magnetic layer, and a recording layer is favorable as a perpendicular magnetic recording medium.

According to the first aspect of the invention, using film comprising a metal and a Si oxide as the primer plating layer, the surface-treated substrate for a magnetic recording medium can contain thick film which has adhesion strong enough to withstand a leveling process such as polishing.

According to a second aspect of the invention, as a result of repeated keen investigations into an surface-treated substrate for a magnetic recording medium, a soft magnetic layer and a magnetic recording medium comprising a recording layer, wherein the surface-treated substrate can contain thick film which is adhesive to a Si substrate, the inventors have found that in order to achieve the object described above, a surface-treated substrate for a magnetic recording medium comprising a Si substrate and a primer plating layer on the Si substrate, wherein at least 5 and at most 50 protrusions of a height of at least 100 nm per 100 μm² are present on a surface of the primer plating layer is effective. The inventors have found that it is effective to have preferably at least 1 and at most 20 protrusions of a height of at least 10 nm per 1 μm² present on the surface of the primer plating layer. The inventors have also found it is preferable that the primer plating layer comprises at least one metal selected from the group consisting of Ag, Co, Cu, Ni, Pt and Pd, or is an alloy whose principal component is at least one of these metals. It should be noted that it is preferable that the content of the principal component is at least 50 wt %. Furthermore, the inventors have found that the soft magnetic layer is preferably disposed on or above the primer plating layer, that the primer plating layer and the soft magnetic layer are preferably formed by wet process plating, and that this magnetic recording medium which comprises the substrate for a magnetic recording medium and a recording layer is favorable as a perpendicular magnetic recording medium.

According to the second aspect of the invention, the adhesion to a layer which is formed on the primer plating layer is improved by providing protrusions on the surface of the primer plating layer in a predetermined range. Consequently, the invention can provide a surface-treated substrate for a magnetic recording medium wherein the surface-treated substrate can contain thick film which has adhesion strong enough to withstand leveling process such as polishing.

According to a third aspect of the invention, as a result of repeated keen investigations into a surface-treated substrate for a magnetic recording medium, a soft magnetic layer and a magnetic recording medium comprising a recording layer, wherein the surface-treated substrate can contain thick film which is adhesive to a Si substrate, the inventors of the invention have found that in order to achieve the object described above, it is effective to use a surface-treated substrate for a magnetic recording medium which comprises a Si substrate, a primer plating layer on the Si substrate and a soft magnetic layer above the primer plating layer, wherein a non-magnetic middle layer is provided between the primer plating layer and the soft magnetic layer. The inventors have also found that it is useful when the non-magnetic middle layer is a Ni—P layer, a Cu layer or a Pd layer. The inventors have found that it is preferable that the mean square roughness (Rms) of a surface of the non-magnetic middle layer is at least 0.1 nm and at most 1 nm, that the thickness is at least 10 nm and at most 500 nm, and further, that the primer plating layer, the non-magnetic middle layer and the soft magnetic layer are formed by wet processing. The inventors have also found that the magnetic recording medium comprising the surface-treated substrate for a magnetic recording medium, a soft magnetic layer and a recording layer is preferable as a perpendicular recording medium.

According to the third aspect of the invention, by comprising a non-magnetic middle layer between the primer plating layer and the soft magnetic layer the invention can provide a surface-treated substrate for a magnetic recording medium wherein the surface-treated substrate can contain thick film which has adhesion strong enough to withstand leveling process such as polishing.

### BRIEF DESCRIPTION OF THE DRAWINGS

FIG. 1 is a schematic view of a surface-treated substrate for a magnetic recording medium of the invention

FIG. 2 is a photo taken by a transmission electron microscope of a cross section of the surface-treated substrate for a magnetic recording medium comprising a soft magnetic layer.

FIG. 3 shows the result of measuring the atomic ratio of metal to Si, from the Si substrate side towards an external side of the primer plating layer, when Ni, Cu, Ag or Co is comprised as the metallic element to form the primer plating layer.

FIG. 4 shows an example of the result of measuring a surface of the primer plating layer by AFM.

FIG. 5 is an example of a perpendicular magnetic recording type hard disk medium of the invention.

FIG. 6 is another example of a perpendicular magnetic recording type hard disk medium of the invention.

### DETAILED DESCRIPTION OF THE INVENTION

By forming a primer plating layer of a highly adhesive material prior to forming a film above a Si substrate, it is possible to obtain a soft magnetic film having favorable adhesion without performing unnecessary roughening, various activation treatments or the like on the substrate surface. In addition, because the invention can be performed by wet process electroless displacement plating, the process is greatly simplified and has excellent productivity compared to plating by vapour deposition method, or the like. Furthermore, the primer plating layer has exceedingly favorable characteristics as a primer film because the surface activity of the primer plating film after film formation is high so that continuous plating is possible without a special activating step.

As the Si substrate of the invention, it is particularly preferable if a Si monocrystalline material manufactured by the CZ (Czochralski) process or the FZ (Floating Zone) method is used. As for the surface orientation of the substrate, any orientation is possible, including for example (1 0 0), (1 1 0) or (1 1 1). Furthermore, it is also possible to comprise an element such as B, P, N, As and Sn and the like as an impurity in the substrate, in a total range of 0 to 10²² atoms/cm². However, when multicrystalline Si having different crystal orientations on the same substrate surface, or Si having excessively localized distribution of impurity is used as a substrate, the primer plating layer which is formed may be non-uniform because of differences in chemical reactivity. Furthermore, if a substrate having the extremely localized distribution is used, it may become impossible to achieve the primer plating layer structure because a local battery is formed in the localized portion of the substrate surface during primer film formation.

In the invention, it is possible to carry out the preferable activation for formation of the primer plating layer by etching slightly the surface oxide layer of the Si substrates. In the invention, it is preferable to etch with an aqueous alkali solution of preferably 2 to 60 wt % caustic soda or the like, and remove the surface oxide layer while corroding slightly the substrate surface. At this time, the etching speed to achieve activation of the base material may be preferably 20 nm/min to 5 μm/min, and as the etched amount, it may be preferable to remove at least 40 nm of base material Si. The temperature of the fluid during etching may differ with concentration and treatment duration, however a range of 30 to 100° C. may be preferable from the point of operability.

After performing such preferably etching, a highly adhesive plating material may be obtained by forming a surface layer by soaking the Si substrate in a plating solution containing at least 0.01 N and preferably 0.05 to 0.3 N of at least one metal ion selected from the group consisting of Ag, Co, Cu, Ni, Pd and Pt, or of said at least one metal ion (elemental component) as a principal metal ion.

The thickness of this primer plating layer may be preferably 10 to 1000 nm, and more preferably 50 to 500 nm. When it is less than 10 nm, a uniform distribution of multicrystalline metal particles within the layer may be obtainable. When it is more than 1000 nm, the individual metal crystals may swell so they may not be suitable as a primer film. It is preferable to use a Si substrate, but in this case as described previously, there may be times in which it is possible to distinguish clearly with transmission electron microscope imaging between the portions of low crystallinity and the amorphous layer directly above the substrate which together constitute this primer plating layer, and there may be times, in which depending on the metal species or manufacturing method used in the present invention, because the composition and crystallinity continuously changes, that boundary is not clear.

It is preferable that film formation is performed by the method generally known as electroless displacement plating. Although use of a solution which does not contain a component which can act as a reducing agent such as hypophosphoric acid and hypochloric acid is the same as in conventional displacement plating, it may be particularly preferable in the invention to use a sulfate salt bath (solution) which does not contain a component serving as a glossing agent such as saccharin. The sulfate salt may include nickel sulfate and copper sulfate, and a preferable concentration thereof may be 0.01 to 0.5 N. A hydrochloric acid bath, or a bath containing no less than 0.05 N of chloride ion may not be preferable, not only because it may be difficult to obtain the primer plating layer of the invention, but also because there may be a case in which plating the Si substrate itself becomes impossible. Furthermore, for the purpose of accomplishing the invention, it may not be preferable to have each individual element such as K, Ca or Na present in the solution at each concentration of no less than 0.003 N. Consequently, chloride ion may be set to less than 0.05 N, and the solution may be set to contain less than 0.003 N of each of K, Ca, and Na and the like.

As the plating condition of the invention, at a temperature of 70 to 100° C. the pH of the solution may be in a range of 7.2 to 12.8, more preferably 7.6 to 8.4. If the temperature of the plating solution is less than 70° C., plating may not be possible. If the plating solution is over 100° C., or the pH is outside the range described above during plating, plating itself may be possible, but the primer plating film according to the present invention may be unobtainable. It may be preferable that pH is controlled by addition of ammonia. If pH control is performed by hydroxides such as caustic soda, it may be problematic to work the invention even if the pH is within the range described above. The reason for this is not completely clear, however it seems very important that the metallic ion in the solution can form complex ion with a complex forming agent such as ammonia.

It is possible to favorably adjust the ammonia dosing amount with the initial pH, however it is also possible to add the ammonia to the plating solution in a range of 0.02 to 0.5 N, preferably in a range of 0.05 to 0.2 N.

It is thus possible to form the primer plating layer by joint use of the etching treatment and primer plating treatment described above.

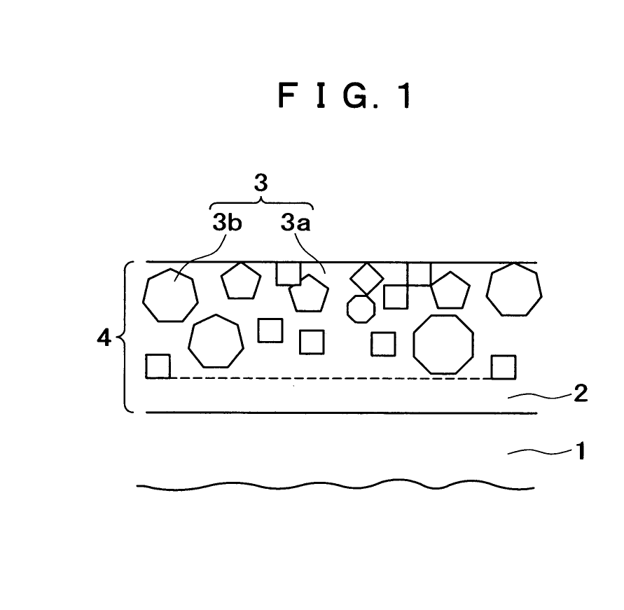

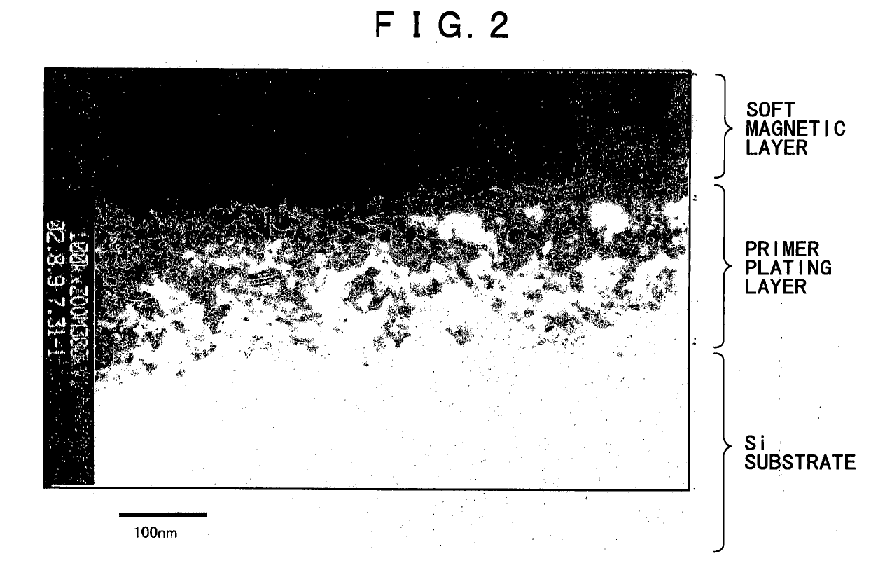

An aspect of the invention in which a Si substrate is used as the non-magnetic substrate is explained below in detail. A schematic view of a surface-treated substrate for a magnetic recording medium is shown in FIG. 1, and a photo taken with a transmission electron microscope of a cross section of a surface-treated substrate for a magnetic recording medium comprising a soft magnetic layer is shown in FIG. 2. As shown here, the primer plating layer of the invention is chemically linked to the elemental silicon of the surface of the Si substrate. When analyzed by electron beam diffraction, the primer plating layer on the Si substrate side shows the characteristic halo pattern of amorphous material, and the metallic component becomes gradually more and the diffraction pattern becomes mixed until a crystalline diffraction pattern is shown on the soft magnetic side. As for the film components, on the Si substrate side, it is mostly Si and non-fixed or irregular composition ratios of silicon oxides, which gradually becomes elemental metal of at least one metal element selected from the group consisting of Ag, Co, Cu, Ni, Pd and Pt. If the boundary of the Si substrate and the primer plating layer is taken to be the place where the amorphous material layer becomes apparent, the atomic ratio between the total of the metal in the primer plating layer and the Si which is the substrate component is preferably (total metal)/Si=0.005 to 100. Furthermore, the metal content increases with increasing distance away from the face of the silicon substrate. Consequently, it seems that adhesion increases between the substrate and the primer layer. Furthermore, it is also possible to contain a small amount of light element such as hydrogen as a component other than these.

Thus, in an embodiment of the invention which uses the Si substrate, the substrate for a magnetic recording medium, which has highly adhesive plating, may have a structure in which a fine metal crystal layer that serves as a nucleus for film growth is dispersed in a layer of low crystallinity in the primer plating layer which is a structural element, the metal crystal layer required as the starting point for film growth is formed in the surface of the primer plating layer, and in which the amorphous layer—mixed crystalline layer continuously changes while ensuring there is firm adhesion to the substrate by the presence of the same elements.

FIG. 1 shows a primer plating layer 4 comprising an amorphous material layer 2 disposed on a Si substrate 1 and a mixed crystalline layer 3, the mixed crystalline layer 3 comprising a low crystalline portion 3a, and a metallic portion 3b.

In an embodiment of the invention which uses the Si substrate, the Si oxide in the primer plating layer is formed due to oxidation of the surface of the Si substrate. The Si oxide is thought to be generated during the step of etching with the alkali solution, or before or during primer plating. It should be noted that the Si oxide in the primer plating layer of the invention is not limited to the Si oxide formed during primer plating, but also comprises those formed before primer plating. That is to say, the primer plating layer starts from the amorphous layer.

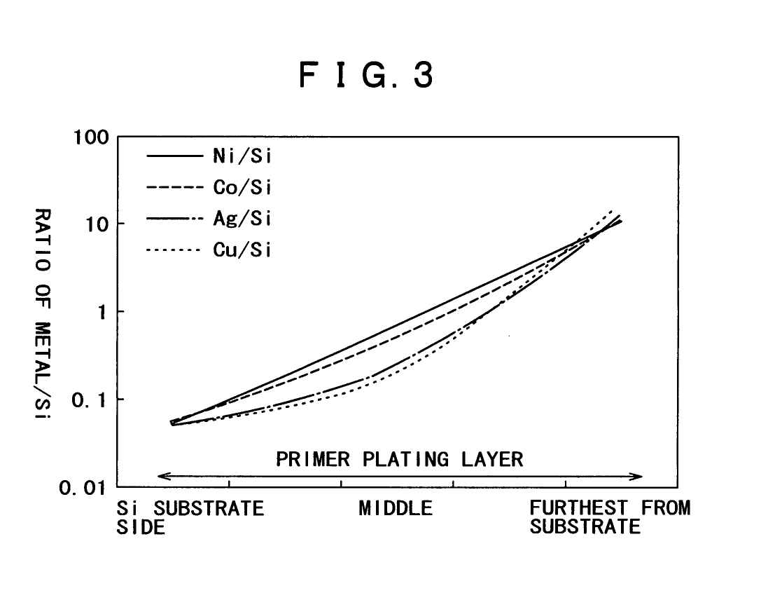

In the embodiment of the invention which uses the Si substrate, when the primer plating layer compries Ni, Cu, Ag, Pd, Pt or Co as the metallic element, the result of measuring the atomic ratio of the metal to Si, from the Si substrate side of the primer plating layer (thickness 200 nm) toward the outer side is shown in FIG. 3. It should be noted that this is only one example, and that the invention is not limited to this. As evident in FIG. 3, the metal content of the primer plating layer increases with increasing distance from the face of the Si substrate.

As described above, the thickness of the primer plating layer is preferably 10 to 1000 nm, more preferably 100 to 500 nm.

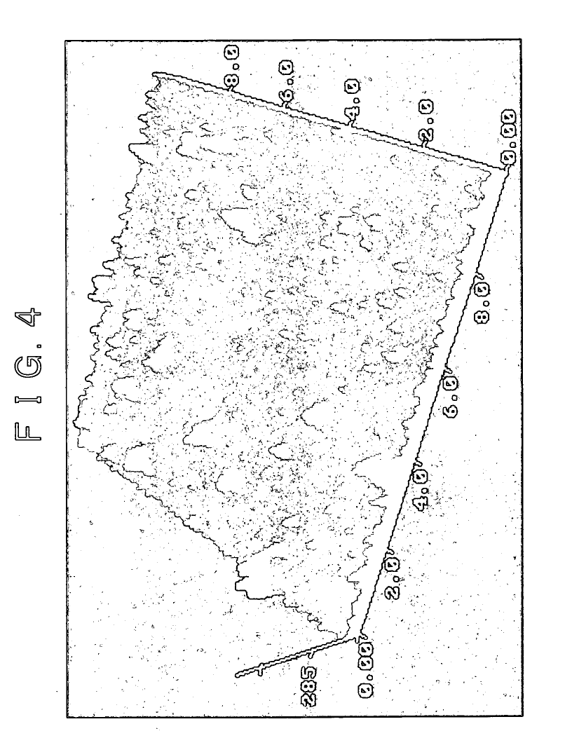

According to the invention, it is preferable that at least 5 and at most 50 protrusions of a height of at least 100 nm per 100 μm², and/or at least 1 and at most 20 protrusions of a height of at least 10 nm per 1 μm² are present on the surface of the primer plating layer. If the number of protrusions is within this range, the reaction area of the primer plating layer becomes large during soft magnetic layer film formation on it due to the anchor effect. Furthermore, because the protrusions become reaction points so that a strong chemical bond can be obtained, it is possible to raise the adhesiveness to, for example, the soft magnetic layer which is formed on the primer plating layer. If the number of protrusions is smaller than this range, the adhesive effect is not obtained. If it is larger than this range, reaction at a bottom portion of the protrusions becomes slow, and a sufficient effect is not obtained. Furthermore, the effect is larger if the protrusions are uniformly distributed. It should be noted that it is possible to measure the height and number of the protrusions by AFM (Atomic Force Microscope). FIG. 4 shows an example of the result of measuring the surface of a primer plating layer by AFM.

It is preferable that a non-magnetic middle layer is comprised between the primer plating layer and the soft magnetic layer. Considering the magnetic shielding between the primer plating layer and the soft magnetic layer (in the case of magnetic materials), and furthermore the uniformity of film formation of the soft magnetic layer and improvement in adhesion, the thickness of the non-magnetic middle layer is preferably at least 10 nm and at most 500 nm. When its thickness is less than 10 nm, there may be no effect. When it is greater than 500 nm, the thickness of the medium itself increases.

There is no particular limitation to the non-magnetic middle layer, other than that the layer is non-magnetic, and the non-magnetic middle layer is preferably selected from the group consisting of a Ni—P layer, a Cu layer and a Pd layer depending on adhesiveness and ease of film formation.

The Ni—P layer is formed for example by soaking in an aqueous solution of nickel sulfate containing hypophosphoric acid, and the Cu layer is formed for example by soaking in an aqueous solution of copper sulfate. Furthermore, the Pd layer is formed by soaking in an aqueous solution of palladium sulfate.

After forming the non-magnetic middle layer, it is preferable to adjust the surface roughness by polishing.

The mean square roughness (Rms) of the surface of the non-magnetic middle layer is preferably at least 0.1 nm and at most 1 nm. It is preferable to provide the average area roughness within this range to give uniformity to film formation and to improve adhesion. Below this range, there may not be only technical difficulties, but adhesion may deteriorate, while above this range, adhesiveness of the primer plating layer may worsen particularly. It should be noted that mean square roughness (Rms) of the surface is the square root of an averaged value of the square of the standard deviation between the measured line and the average of the measured line, and can be measured by AFM (Atomic Force Microscope).

Although there is no particular limitation, polish can be mechanical polishing or Chemical Mechanical Polishing (CMP). CMP differs from polishing with just regular polishing slurry, in that CMP is performed while chemically polishing with an acidic or alkali polishing solution as well. Colloidal alumina or colloidal silica or the like can be used as a polishing medium. Because the polishing speed of CMP which uses colloid-based polishing media is particularly fast and the surface roughness is noticeably improved, it is suitable as a polishing method for perpendicular magnetic recording media. In addition to the particle diameter of colloid-based polishing media being exceedingly small at 10 to 100 nm, the particles are close to spherical in shape, enabling excellent smoothness to be realized. Furthermore, because CMP does not simply mechanically polish away the surface but performs polishing by a process which is similar to chemically dissolving the surface, a polishing speed that is sufficient for industrial use can be maintained even by using fine spherical-shaped polishing media.

It is possible to form the soft magnetic layer on or above the primer plating layer of the invention. There is no particular limitation to the soft magnetic layer and any soft magnetic layer material known in the art can be used. The soft magnetic layer may preferably comprise one or more selected from the group consisting of Fe, Co, Ni, P, Nb, Zr, B and V. It may preferably comprise permalloy (Fe₈₀Ni₂₀) for example.

The method for forming the soft magnetic layer is also not limited particularly, and any method known in the art can be used. For example it is possible to use sputtering.

The thickness of the soft magnetic layer is dependent on its application and conditions of use, and may be for example 100 to 1000 nm, preferably 100 to 500 nm.

The magnetic recording medium of the invention may be preferably a perpendicular magnetic recording medium. The magnetic recording medium of the invention comprises a Si substrate, a primer plating layer, (preferably with a non-magnetic middle layer) and a soft magnetic layer. The soft magnetic layer can be a single layer, or it can be a multi-layer which is constituted by a plurality of films. According to the invention, it is preferable that the primer plating layer, the non-magnetic middle layer and the soft magnetic layer are formed by wet process plating. By forming these layers using wet process plating, the process is simple with superior productivity, continuous film formation is possible while maintaining activity, and very superior characteristics can be achieved.

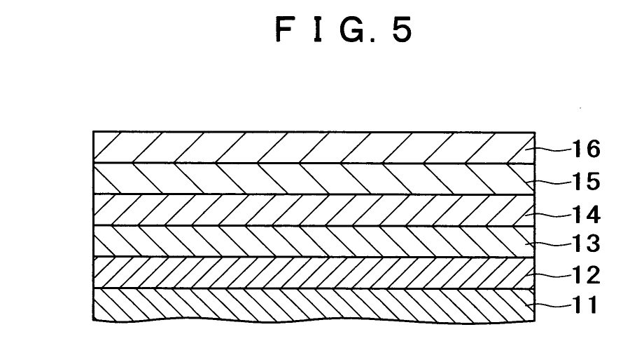

FIG. 5 shows an example of a perpendicular magnetic recoding type hard disk medium of the invention. The substrate for the magnetic recording medium of the invention, which comprises a Si substrate 11, a primer plating layer 12 and a soft magnetic layer 13, can be made into a magnetic recording medium by comprising a recording layer 14 disposed on the soft magnetic layer 13. Furthermore, it is also possible to provide a protective layer 15 and a lubricating layer 16 in that order on the recording film. These layers can be formed by methods known in the art such as sputtering.

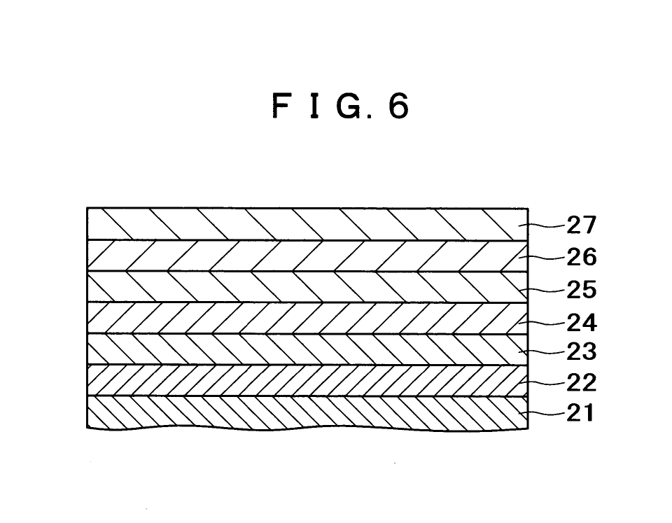

FIG. 6 shows an example of a perpendicular recording type hard disk medium which comprises a non-magnetic middle layer. The substrate for the magnetic recording medium of the invention, which comprises a Si substrate 21, a primer plating layer 22, a non-magnetic middle layer 23 and a soft magnetic layer 24, can be made into a magnetic recording medium by comprising a recording layer 25 disposed on the soft magnetic layer 24. Furthermore, it is also possible to provide a protective layer 26 and a lubricating layer 27 in that order on the recording film. These layers can be formed by methods known in the art such as sputtering.

A Co recording layer is an example of a recording layer, a carbon protective layer is an example of a protective layer, and a fluorine based lubricating layer is an example of a lubricating layer. That is to say, the recording layer, the protective layer and the lubricating layer can be as known in the art. The thickness of these layers will fluctuate with application and conditions of use.

According to the invention, the soft magnetic layer and the recording layer may be provided on a single side of the substrate, or the soft magnetic layer and the recording layer may be provided on both sides of the substrate.

The invention will be explained based on the examples below, however the present invention is not limited to these.

### EXAMPLE 1

Both surfaces of a (1 0 0) Si monocrystal (P doped N type substrate) having a diameter of 65 mm which had been produced by cutout, edge-removal and lapping of a 200 mm diameter Si monocrystalline substrate fabricated by the CZ process, were polished with colloidal silica of a mean particle size of 15 nm so as to have a surface roughness (Rms) of 4 nm. The Rms means a mean square roughness and was measured using an AFM (Atomic Force Microscope). Si etching was performed on the surface while the thin surface oxide film was removed from the surface of the substrate by soaking for 3 minutes in a 10 wt % aqueous caustic soda solution at 45° C. Next, a primer plating bath was prepared by adding 0.5 N of ammonium sulfate into a 0.1 N aqueous nickel sulfate solution, and the pH was brought up to 9.8 by further addition of ammonia water. This solution was heated to 80° C., and when the pH was measured again, it was 7.6. While adding ammonia water continuously to bring the pH to 8.0 at 80° C. (the total amount of ammonia water was 0.1 N), the primer plating layer was formed by soaking the previously etched Si substrate in the primer plating bath for 5 minutes.

Observing the surface of this material with a transmission electron microscope, an amorphous layer just on or above the Si substrate and a crystalline layer on or above the amorphous layer were confirmed. Furthermore, as a result of investigating the composition ratio (atomic ratio) of the Si and metal components by EDX, the ratio of Si:Ni in a portion just above the Si substrate was 19:1. Furthermore, the composition ratio (atomic ratio) of Si:Ni in a middle portion in the thickness direction was 3:2, and that of the portion furthest from the substrate was Si:Ni=1:10. Inserting lattice-shaped cuts at 5 mm intervals into this primer plating film, sellotape (registered trade mark) was used to make a peel off test, and delamination of the plated film was not observed at all.

### EXAMPLE 2

Si etching was performed on the surface of a Si substrate which had been obtained in the same manner as in Example 1, while the thin surface oxide film was removed from the surface of the substrate by soaking for 2 minutes in a 45 wt % aqueous caustic soda solution at 50° C. Next, a primer plating bath was prepared by adding a 0.2 N aqueous ammonium sulfate solution into a 0.2 N aqueous copper sulfate solution, and the pH was brought up to 8.3 by further addition of ammonia water. This solution was heated to 80° C., and when the pH was measured again, it was 6.9. While adding ammonia water continuously to bring the pH to 8.0 at 80° C. (the total amount of ammonia was 0.2 N), the highly adhesive primer plating film of the invention was obtained by soaking the previously etched Si substrate in the primer plating bath for 7 minutes.

Observing the surface of this material with transmission electron microscope, an amorphous layer on or above the Si substrate and a mixed crystalline layer on or above the amorphous layer were confirmed. Furthermore, as a result of investigating the composition ratio (atomic ratio) of the Si and metal components by EDX, the ratio of Si:Cu in a portion just above the Si substrate was 20:1. Furthermore, the composition ratio (atomic ratio) of Si:Cu in a middle portion in the thickness direction was 5:1, and that of the portion furthest from the substrate was Si:Cu=1:15. Inserting lattice-shaped cuts at 5 mm intervals into this primer plating film, sellotape (registered trade mark) was used to make a peel off test, and delamination of the plated film was not observed at all.

### EXAMPLE 3

Si etching was performed on the surface of a Si substrate which had been obtained in the same manner as in Example 1, while the thin surface oxide film was removed from the surface of the substrate by soaking for 3 minutes in a 30 wt % aqueous caustic soda solution at 30° C. Next, a primer plating bath was prepared by adding a 0.15 N aqueous ammonium sulfate solution into a 0.15 N aqueous silver nitrate solution, and the pH was brought up to 8.8 by further addition of ammonia water. This solution was heated to 80° C., and when the pH was measured again, the pH was 7.2. While adding ammonia water continuously to bring the pH to 8.0 at 80° C. (the total amount of ammonia was 0.15 N), the highly adhesive primer plating film of the invention was obtained by soaking the previously etched Si substrate in the primer plating bath for 3 minutes. Observing the surface of this material with a transmission electron microscope, an amorphous layer on or above the Si substrate and a mixed crystalline layer on or above the amorphous layer were confirmed. Furthermore, as a result of investigating the composition ratio (atomic ratio) of the Si and metal components by EDX, the ratio of Si:Ag in a portion just above the Si substrate was 20:1. Furthermore, the composition ratio (atomic ratio) of Si:Ag in a middle portion in the thickness direction was 4:1, and that of the portion furthest from the substrate was Si:Ag=1:12. Inserting lattice-shaped cuts at 5 mm intervals into this primer plating film, sellotape (registered trade mark) was used to make a peel off test, and delamination of the plated film was not observed at all.

### EXAMPLE 4

Si etching was performed on the surface of a Si substrate which had been obtained in the same manner as in Example 1, while the thin surface oxide film was removed from the surface of the substrate in the same manner as in Example 1. Next, a primer plating bath was prepared by adding a 0.2 N aqueous ammonium sulfate solution into a 0.2 N aqueous cobalt sulfate solution, and the pH was brought up to 8.5 by further addition of ammonia water. This solution was heated to 80° C., and when the pH was measured again, it was 7.0. While adding ammonia water continuously to bring the pH to 8.0 at 80° C. (the total amount of ammonia was 0.2 N), the highly adhesive primer plating film of the invention was obtained by soaking the previously etched Si substrate in the primer plating bath for 5 minutes. Observing the surface of this material with a transmission electron microscope, an amorphous layer on or above the Si substrate and a mixed crystalline layer on or above the amorphous layer were confirmed. Furthermore, as a result of investigating the composition ratio (atomic ratio) of the Si and metal components by EDX, the ratio of Si:Co in a portion just above the Si substrate was 18:1. Furthermore, the composition ratio (atomic ratio) of Si:Co in a middle portion in the thickness direction was 2:1, and that of the portion furthest from the substrate was Si:Co=1:10.

Inserting lattice-shaped cuts at 5 mm intervals into this primer plating film, sellotape (registered trade mark) was used to make a peel off test, and delamination of the plated film was not observed at all.

### EXAMPLE 5

Both surfaces of a (1 0 0) Si monocrystal (P doped N type substrate) having a diameter of 65 mm which had been produced by cutout, edge-removal and lapping of a 200 mm diameter Si monocrystalline substrate fabricated by the CZ process were polished with colloidal silica of a mean particle size of 15 nm so as to obtain a surface roughness (Rms) of 4 nm. The Rms means a mean square roughness and was measured using an AFM (Atomic Force Microscope). After Si-etching on the surface was performed while the thin surface oxide film was removed from the surface of the substrate by soaking for 3 minutes in a 10 wt % aqueous caustic soda solution at 45° C., this substrate was successively soaked in ethylene glycol solution.

Next, a primer plating bath was prepared by adding 0.5 N of ammonium sulfate into a 0.1 N aqueous nickel sulfate solution, and the pH was brought up to 9.8 by further addition of ammonia water. This solution was heated to 80° C., and when the pH was measured again, the pH was 7.6. While adding ammonia water continuously to bring the pH to 8.0 at 80° C. (the total amount of ammonia was 0.1 N), the primer plating layer was obtained by soaking the previously etched Si substrate in the primer plating bath for 5 minutes.

After measuring the surface of this material with an AFM (Atomic Force Microscope), 35 protrusions of a height of at least 100 nm were observed per 100 μm².

Inserting lattice-shaped cuts at 5 mm intervals into this primer plating film, sellotape (registered trade mark) was used to make a peel off test, and delamination of the plated film was not observed at all.

### EXAMPLE 6

Si etching was performed on the surface of a Si substrate which had been obtained in the same manner as in Example 5, while the thin surface oxide film was removed from the surface of the substrate by soaking for 2 minutes in a 45 wt % aqueous caustic soda solution at 50° C.

Next, a primer plating bath was prepared by adding a 0.2 N aqueous ammonium sulfate solution into a 0.2 N aqueous copper sulfate solution, and the pH was brought up to 8.3 by further addition of ammonia water. This solution was heated to 80° C., and when the pH was measured again, it was 6.9. While adding ammonia water continuously to bring the pH to 8.0 at 80° C. (the total amount of ammonia was 0.2 N), the highly adhesive primer plating film of the invention was obtained by soaking the previously etched Si substrate in the primer plating bath for 7 minutes.

After measuring the surface of this material with an AFM (Atomic Force Microscope), 18 protrusions of a height of at least 10 nm were observed per 1 μm².

Inserting lattice-shaped cuts at 5 mm intervals into this primer plating film, sellotape (registered trade mark) was used to make a peel off test, and delamination of the plated film was not observed at all.

### EXAMPLE 7

Both surfaces of a (1 0 0) Si monocrystal (P doped N type substrate) having a diameter of 65 mm which had been produced by cutout, edge-removal and lapping of a 200 mm diameter Si monocrystalline substrate fabricated by the CZ process were polished with colloidal silica of a mean particle size of 15 nm so as to obtain a surface roughness (Rms) of 4 nm. The Rms means a mean square roughness and was measured using an AFM (Atomic Force Microscope). After Si-etching on the surface was performed while the thin surface oxide film was removed from the surface of the substrate by soaking for 3 minutes in a 10 wt % aqueous caustic soda solution at 45° C., this substrate was subsequently soaked in ethylene glycol solution.

Next, a primer plating bath was prepared by adding 0.5 N of ammonium sulfate into a 0.1 N aqueous nickel sulfate solution, and the pH was brought up to 9.8 by further addition of ammonia water. This solution was heated to 80° C., and when the pH was measured again, the pH was 7.6. While adding ammonia water continuously to bring the pH to 8.0 at 80° C. (the total amount of ammonia was 0.1 N), the primer plating layer was obtained by soaking the previously etched Si substrate in the primer plating bath for 5 minutes. Continuingly, the middle layer was obtained by dipping for 5 minutes in a 0.1 N aqueous nickel sulfate solution which contains hypophosphoric acid.

Observing the surface of this material with a transmission electron microscope and AMF, it had a thickness of 250 nm and a Rms of 0.8 nm.

Inserting lattice-shaped cuts at 5 mm intervals into this primer plating film, sellotape (registered trade mark) was used to make a peel off test, and delamination of the plated film was not observed at all.

### EXAMPLE 8

Si etching was performed on the surface of a Si substrate which was produced in the same manner as in Example 7, while the thin surface oxide film was removed from the surface of the substrate by soaking for 2 minutes in a 45 wt % aqueous caustic soda solution at 50° C.

Next, a primer plating bath was prepared by adding a 0.2 N aqueous ammonium sulfate solution into a 0.2 N aqueous copper sulfate solution, and the pH was brought up to 8.3 by further addition of ammonia water. This solution was heated to 80° C., and when the pH was measured again, it was 6.9. While adding ammonia water continuously to bring the pH to 8.0 at 80° C. (the total amount of ammonia was 0.2 N), the highly adhesive primer plating film of the invention was obtained by soaking the previously etched Si substrate in the primer plating bath for 7 minutes. Continuingly, the middle layer was obtained by dipping for 5 minutes in a 0.1 N aqueous nickel sulfate solution.

Observing the surface of this material with a transmission electron microscope and AMF, it had a thickness of 15 nm and a Rms of 0.2 nm.

Inserting lattice-shaped cuts at 5 mm intervals into this primer plating film, sellotape (registered trade mark) was used to make a peel off test, and delamination of the plated film was not observed at all.

1. A surface-treated substrate for a magnetic recording medium, comprising:
a Si substrate; and
a primer plating layer on the Si substrate;
wherein the primer plating layer is a film which comprises a metal and a Si oxide.

2. The surface-treated substrate for a magnetic recording medium according to claim 1,
wherein a metal content of said primer plating layer increases with increasing distance from a face of said Si substrate.

3. The surface-treated substrate for a magnetic recording medium according to claim 1,
wherein said metal of said primer plating layer comprises at least one metal selected from the group consisting of Ag, Co, Cu, Ni, Pd and Pt, or comprises an alloy comprising said at least one metal.

4. The surface-treated substrate for a magnetic recording medium according to claim 1, further comprising:
a soft magnetic layer disposed on or above said primer plating layer.

5. A magnetic recording medium comprising:
said surface-treated substrate for a magnetic recording medium according to claim 1; and
a recording layer.

6. A surface-treated substrate for a magnetic recording medium, comprising:
a Si substrate; and
a primer plating layer on the Si substrate,
wherein at least 5 and at most 50 protrusions of a height of at least 100 nm per 100 m² are present on a surface of the primer plating layer.

7. A surface-treated substrate for a magnetic recording medium, comprising:
a Si substrate; and
a primer plating layer on the Si substrate,
wherein at least 1 and at most 20 protrusions of a height of at least 10 nm per 1 m² are present on a surface of the primer plating layer.

8. The surface-treated substrate for a magnetic recording medium according to claim 6,
wherein said primer plating layer is at least one metal selected from the group consisting of Ag, Co, Cu, Ni, Pt and Pd, or is an alloy whose principal component is said at least one metal.

9. The surface-treated substrate for a magnetic recording medium according to claim 6, further comprising:
a soft magnetic layer disposed on or above said primer plating layer.

10. The surface-treated substrate for a magnetic recording medium according to claim 6,
wherein said primer plating layer and said soft magnetic layer have been formed by wet process plating.

11. A magnetic recording medium comprising:
said surface-treated substrate for a magnetic recording medium according to claim 6; and
a recording layer on or above said substrate.

12. A surface-treated substrate for a magnetic recording medium, comprising:
a Si substrate;
a primer plating layer on the Si substrate; and
a soft magnetic layer above the primer plating layer,
wherein a non-magnetic middle layer exists between the primer plating layer and the soft magnetic layer.

13. The surface-treated substrate for a magnetic recording medium according to claim 12,
wherein the non-magnetic middle layer is selected from the group consisting of a Ni—P layer, a Cu layer and a Pd layer.

14. The surface-treated substrate for a magnetic recording medium according to claim 12,
wherein a mean square roughness (Rms) of a surface of said non-magnetic middle layer is at least 0.1 nm and at most 1 nm, and thickness of said non-magnetic middle layer is at least 10 nm and at most 500 nm.

15. The surface-treated substrate for a magnetic recording medium according to claim 12,
wherein said primer plating layer, said non-magnetic middle layer and said soft magnetic layer have been formed by wet process plating.

16. A magnetic recording medium comprising:
said surface-treated substrate for a magnetic recording medium according to claim 12; and
a recording layer on the substrate.

17. The surface-treated substrate for a magnetic recording medium according to claim 7,
wherein said primer plating layer is at least one metal selected from the group consisting of Ag, Co, Cu, Ni, Pt and Pd, or is an alloy whose principal component is said at least one metal.

18. The surface-treated substrate for a magnetic recording medium according to claim 7, further comprising:
a soft magnetic layer disposed on or above said primer plating layer.

19. The surface-treated substrate for a magnetic recording medium according to claim 7,
wherein said primer plating layer and said soft magnetic layer have been formed by wet process plating.

20. A magnetic recording medium comprising:
said surface-treated substrate for a magnetic recording medium according to claim 7; and
a recording layer on or above said substrate.
